(19) United States
(12) Patent Application Publication
(10) Pub. No.: US 2012/0163383 A1
(43) Pub. Date: Jun. 28, 2012

(54) Method and device for transmitting data between two secured ethernet-type networks through a routed network

(75) Inventor: Ben Youcef ECH-CHERGUI, Colombes (FR)

(73) Assignee: THALES, Neuilly Sur Seine (FR)

(21) Appl. No.: 13/333,234

(22) Filed: Dec. 21, 2011

(30) Foreign Application Priority Data
Dec. 22, 2010 (FR) 1005041

(51) Int. Cl. H04L 12/56

(52) U.S. Cl. 370/392

(57) ABSTRACT

This method for transmitting data between a starting network and a receiving network through a transit network comprises, during a transmission of data comprised in at least one frame of a data link layer: encapsulation of the frame in at least one packet of a network layer compatible with the transit network, and transmission of each packet to the receiving network. Each packet is a secured packet, and the encapsulation step comprises the following steps: generating at least one security encapsulation header, forming at least one encapsulation packet comprising at least one of the security encapsulation header(s) and the frame or a fragment of the frame, forming each secured packet by applying at least one cryptographic protection to each encapsulation packet.

The present disclosure relates to a method for transmitting data over a communication channel between at least one starting network and at least one receiving network through a transit network with a different security level from the starting and receiving networks, comprising, during a transmission, from the starting network to the receiving network through the transit network, data comprised in at least one frame of the data link layer, the frame comprising at least one header and a payload:

a step for encapsulating the frame in at least one packet of a level 3 network layer of the OSI model, compatible with the transit network, and

a step for transmitting the or each packet to the receiving network through the transit network.

It is in particular applicable to the transmission of data between two secured switched networks, for example two Ethernet networks of a corporate, through a public routed network, for example the Internet.

Within a switched secured network such as an Ethernet network, data is exchanged between the different terminals in the form of frames of layer 2 of the OSI model, i.e. the link layer, for example according to the Ethernet protocol. Such frames cannot circulate in that state on a routed public network, for example on an IP network, as they do not contain any level 3 information of the OSI model, i.e. the network layer of that model.

Although this partitioning makes it possible to ensure that no sensitive data leaves the secured network and enters an external network with a lower security level, it also prevents the exchange of data between two remote secured networks, for example two remote secured networks of a same corporate, through a routed transit network.

Known from document WO 2008/039486 A2 is a method for encapsulating Ethernet frames in secured Ethernet frames, so as to secure the exchange of those Ethernet frames between two Ethernet networks through a transit network also of the Ethernet type.

However, this method does not make it possible to exchange Ethernet frames through a routed network, as the obtained secured Ethernet frames do not comprise any level 3 information. Furthermore, the protection provided to the Ethernet frames by this method does not make it possible to make the exchanges between the two Ethernet networks anonymous, the identities of the source and destination terminals of these exchanges remaining visible. This method also does not make it possible to protect the exchanged frames from attacks from the transit network, in particular from attacks on the encapsulation header comprising security data. Such attacks can cause unavailability on the flows, thereby preventing two protected networks from exchanging data.

To allow a secured exchange between two secured switched networks through public routed network, it is known to place an encryptor on each of the switched networks, and to place a specific architecture between the two encryptors, intended to create a virtual sub-network between the two encryptors, the two encryptors communicating as if they were on the same Ethernet network. However, this solution is very restrictive in terms of use and very expensive. In particular, such an architecture only makes it possible to create a point-to-point connection between no more than two encryptors, and requires the creation of a specific infrastructure between those two encryptors.

The aim of the disclosure is therefore to allow a secured exchange between at least two remote switched networks through a routed network with a lower security level, the placement of which is both less expensive and more flexible than the exchanges according to the state of the art.

To that end, the disclosure relates to a transmission method of the aforementioned type, characterized in that the or each packet is a secured packet and in that the encapsulation step comprises the following steps:

generating at least one security encapsulation header,

forming at least one encapsulation packet comprising at least the or one of the security encapsulation header(s) and the frame or a fragment of the frame,

forming the or each secured packet by applying at least one cryptographic protection to the or each encapsulation packet.

The transmission method according to the disclosure also comprises the following features, considered separately or in combination:

the encapsulation step also comprises a step for making the or each secured packet anonymous, comprising adjusting the length of the or each secured packet (P sec) to a predefined length,

the transmission method also comprises, during the transmission of at least one frame of the data link layer from the starting network to the receiving network through the transit network, before the encapsulation step:

comparing a size of the frame to a predefined maximum size,

if the size of the frame is larger than the predefined maximum size, fragmenting the frame into at least two frame fragments, the size of each frame fragment being smaller than or equal to the predefined maximum size,

the transmission method also comprises the generation of at least one trailer, the or each encapsulation packet comprising at least one of the security encapsulation header(s), the frame or a fragment of the frame and the or one of the trailer(s),

the or each trailer comprises traffic padding data, the length of the traffic padding data being chosen so that the length of the or each secured packet is equal to the predefined length,

the transmission method also comprises, during a transmission of at least one secured packet from the transit network to the receiving network, at least one step for receiving the or each secured packet, and a step for transmitting the data to the receiving network, the or each receiving step comprising:

cryptographic verification of the encapsulation packet comprised in the secured packet,

extraction of the frame or frame fragment comprised in the encapsulation packet,

the transmission method comprises, if at least two encapsulation packets comprise a fragment of the frame, an assembly of the fragments of the frame comprised in the encapsulation packets, before the step for transmitting the data to the receiving network,

the frame is an Ethernet frame, and

the secured packet comprises a secured packet according to an IPsec protocol.

The disclosure also relates to a device for transmitting data on a communication channel between at least one starting network and a receiving network through a transit network with a different security level from the starting and receiving networks, comprising:

encapsulation means, capable of encapsulating a frame of a data link layer, comprising at least one header and a payload, in at least one packet of a network layer compatible with the transit network, and

means for transmitting the or each packet toward the receiving network through the transit network,

the device being characterized in that the or each packet is a secured packet and in that the encapsulation means comprise:

means for generating at least one security encapsulation header,

means for forming at least one encapsulation packet comprising at least the or one of the security encapsulation header(s) and the frame or a fragment of the frame,

means for forming the or each secured packet by applying at least one cryptographic protection to the or each encapsulation packet.

The disclosure will be better understood in light of the examples of embodiments of the disclosure that will be described below in reference to the appended figures, in which:

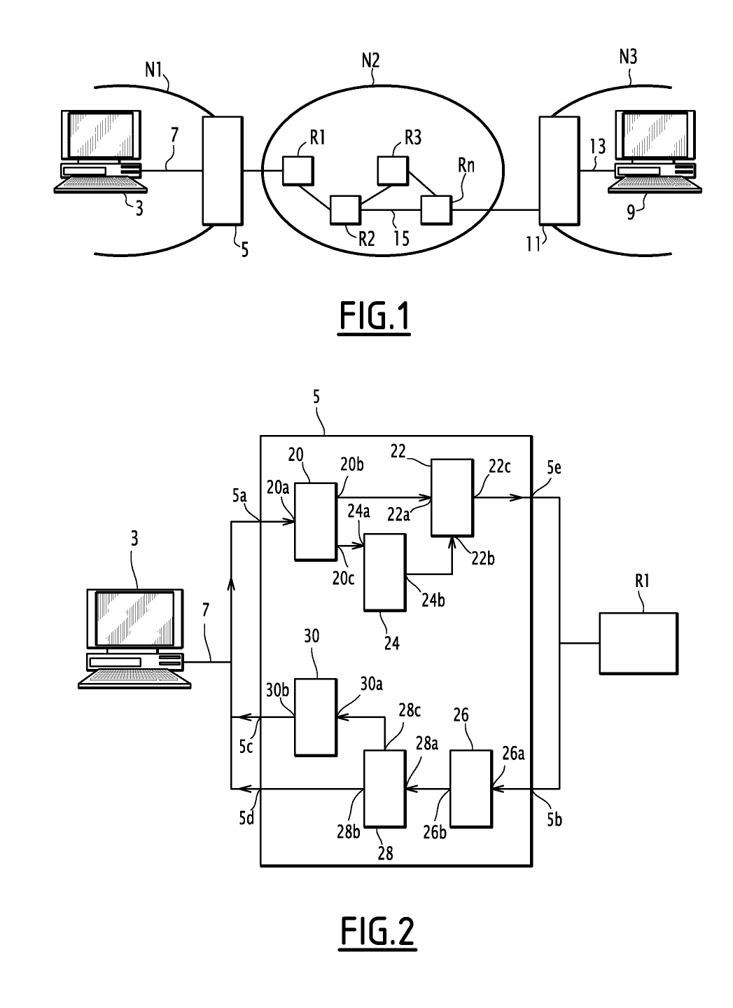

FIG. 1 is a diagram illustrating the overall architecture of networks adapted for the implementation of the inventive method;

FIG. 2 is a diagram of a transmission device according to one embodiment of the disclosure;

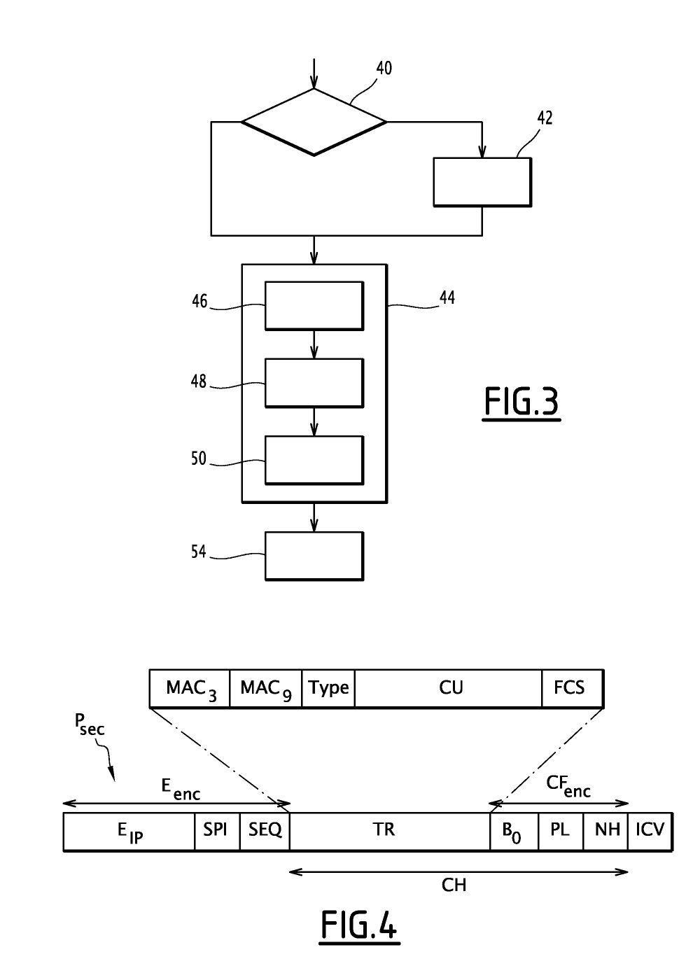

FIG. 3 is an overview diagram illustrating the steps of the method according to one embodiment of the disclosure, implemented by the transmission device of FIG. 2;

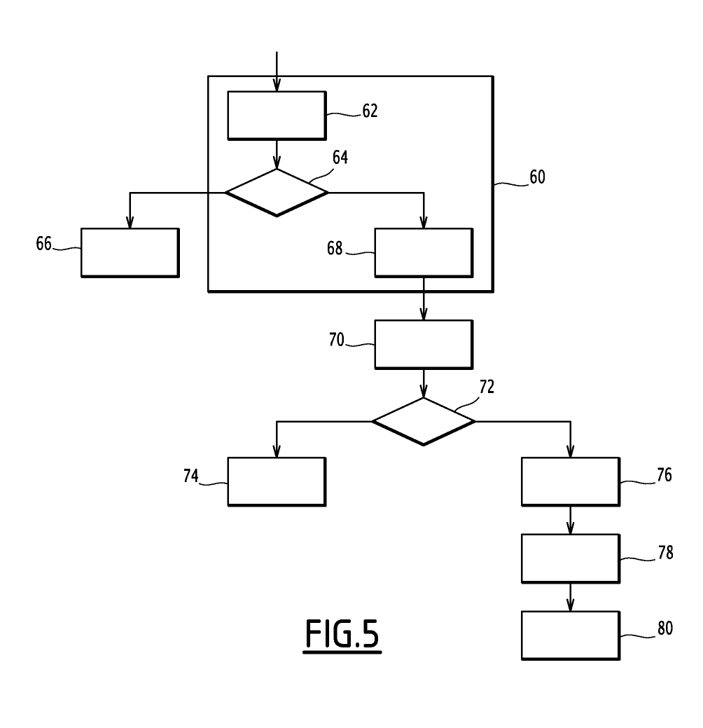

FIG. 4 is a diagram illustrating the structure of the secured packet as transmitted by the transmission device of FIG. 2; and

FIG. 5 is an overview diagram illustrating other steps of the method according to one embodiment of the disclosure, implemented by a transmission device as illustrated in FIG. 2.

FIG. 1 illustrates the overall architecture of networks adapted to the implementation of the method according to one embodiment of the disclosure.

Two secured telecommunications networks N1 and N3, hereafter respectively called starting and receiving networks, are capable of communicating through a transit network N2, with a lower security level than the secured networks N1 and N3.

The secured networks N1 and N3 are for example internal company networks, i.e. local networks, each comprising several pieces of computer equipment. Within each of these networks, this equipment is capable of exchanging data in a secure manner, according to a local network protocol of the link layer 2 of the OSI model, for example according to the Ethernet protocol.

The transit network N2 is a routed network with a lower security level than the secured networks N1 and N3, for example a public network such as the Internet, on which data passes according to a protocol of the network layer 3 of the OSI model, for example according to the IP protocol.

We will hereafter consider that the secured networks N1 and N3 are Ethernet networks, and that the transit network N2 is an IP network.

The starting network N1 comprises at least one transmitting terminal 3 and a security device 5, connected by a wired or wireless connection 7 to the transmitting terminal 3.

The transmitting terminal 3, for example a computer, is capable of exchanging data with the starting network N1, and in particular with the transmission device 5, with the transit network N2, and with the receiving network N3, via the data transmission device 5. The transmitting terminal 3 in particular comprises a network card, capable of exchanging data with the starting network N1, in particular with the transmission device 5, and with transit device N2.

The data transmission device 5 is interposed in series between the starting network N1 and the transit network N2, such that all of the data exchanged between the transmitting terminal 3 and the transit network N2 must pass through the device 5.

The transmission device 5 is capable of encapsulating a frame of a data link layer of the starting network N1, comprising at least one header and a payload, in at least one secured packet of a network layer compatible with the transit network N2, and capable of transmitting this or these secured packet(s) to the receiving network N3 through the transit network N2.

This transmission device 5 will be described in detail in reference to FIG. 2.

The receiving network N3 comprises at least one receiving terminal 9 and a security device 11, connected by a wired or wireless connection 13 to the receiving terminal 9.

The receiving terminal 9, for example a computer, is capable of exchanging data with the receiving network N3, and in particular with the transmission device 11, with the transit network N2, and with the starting network N1, via the transmission device 11. The receiving terminal 9 in particular comprises a network card, capable of exchanging data with the receiving network N3, in particular with the transmission device 11, and with the transit network N2.

The transmission device 11 is installed in cut between the transit network N2 and the receiving network N3. Its structure and operation are identical to the transmission device 5 of the starting network N1.

The transit network N2 in particular comprises several routers R₁, R₂, R₃, Rₙ, interconnected by a meshing of connections 13, which are for example wired connections or wireless connections. Furthermore, at least one router R₁ is connected to the transmission device 5 of the starting network N1, and at least one router Rₙ is connected to the transmission device 11 of the receiving network N3.

In a known manner, the routers R₁, R₂, R₃, Rₙ are capable of making data pass between the transmission devices 5, 11 of the starting and receiving networks N1, N3.

FIG. 2 illustrates, in a simplified manner, the architecture of the transmission device 5, interposed in series between the transmitting terminal 3 and the router R₁ of the transit network N2, both shown diagrammatically.

The transmission device 5 comprises a first analysis module 20, an encapsulation and protection module 22, and defragmenting module 24, as well as a cryptographic verification module 26, a decapsulation module 28, and a reassembly module 30.

The device 5 comprises a first inlet 5a connected to the transmitting terminal 3 by the connection 7, a second inlet 5b connected to the router R₁, first and second outlets 5c and 5d connected to the transmitting terminal 3 by the connection 7, and a third outlet 5e connected to the router R₁.

The analysis module 20 comprises an inlet 20a, connected to the first inlet 5a of the device 5, and first and second outlets 20b, 20c.

The fragmenting module 24 comprises an inlet 24a, connected to the second outlet 20c of the analysis module 20, and an outlet 24b.

The encapsulation and security module 22 comprises a first inlet 22a, connected to the first outlet 20b of the analysis module 20, a second inlet 22b, connected to the outlet 24b of the fragmenting module, and an outlet 22c, connected to the third outlet 5e of the device 5.

The cryptographic verification module 26 comprises an inlet 26a, connected to the second inlet 5b of the device 5, and an outlet 26b.

The decapsulation module 28 comprises an inlet 28a, connected to the outlet 26b of the cryptographic verification module 26, a first outlet 28b, connected to the second outlet 5d of the device 5, and a second outlet 28c.

The reassembly module 30 comprises an inlet 30a, connected to the second outlet 28c of the decapsulation module 28, and an outlet 30b, connected to the first outlet 5c of the device 5.

The analysis module 20 is capable of receiving a frame of a link layer of the network N1 transmitted by the transmitting terminal 3, analyzing that frame to determine whether fragmentation of that frame is necessary before transmission thereof on the transit network N2. The analysis module 20 is also capable of transmitting that frame to the fragmenting module 24 if fragmentation is necessary, or to the encapsulation and security module 22 if not.

The fragmenting module 24 comprises means for fragmenting a frame received from the analysis module 20 into as many frame portions as necessary, and forming, from each of those portions, a frame fragment, comprising one of the frame portions resulting from the fragmentation, and a field indicating the position of that portion in the original frame and making it possible to identify the original frame. The fragmenting module 24 is also capable of transmitting the frame fragments thus formed to the encapsulation security module 22.

The encapsulation security module 22 is capable of encapsulating each frame or frame fragment it receives in a secured level 3 packet. In particular, the encapsulation module 22 is capable of generating at least one security encapsulation header, forming at least one encapsulation packet comprising at least one security encapsulation header, the frame or a fragment of the frame and a trailer, applying at least one cryptographic protection to each encapsulation packet, thereby forming at least one secured packet.

The encapsulation and security module 22 is also capable of transmitting the secured packet(s) thus formed through the transit network N2, to the transmission device 11.

The cryptographic verification module 26 is capable of receiving secured data packets having passed through the transit network N2, analyzing those packets to verify the authenticity and integrity thereof, and decrypting any parts of those packets having undergone encryption.

The decapsulation module 28 comprises means for extracting, from a secured packet, a frame or a frame fragment contained in that packet, by decapsulation of the packet, i.e. eliminating a header and a trailer added to the frame or frame fragment beforehand. The decapsulation module 28 is also capable of analyzing the data resulting from the decapsulation, to determine whether it involves a whole frame or a frame fragment, transmitting the whole frames on the network N1, to the terminal receiving those frames, and the frame fragments to the reassembly module 30.

The reassembly module 30 comprises means for reforming, from at least two frame fragments received from the decapsulation module 28, the frame from which those fragments were generated, and transmitting the reconstituted frame on the network N1, to the terminal receiving that frame.

The transmission device 5 is preferably installed in a controlled space, for example in an enclosure of the network N1, so as to physically protect its inlets and outlets from potential attackers. The transmission device 5 is for example physically shielded, in particular to prevent attacks through auxiliary channels, particularly via the analysis of the electrical current consumed by the device or the electromagnetic radiation emitted by the device.

FIG. 3 illustrates the steps carried out by the transmission device 5 when it receives data transmitted by the transmitting terminal 3 intended for the receiving terminal 9, this data being transmitted according to a protocol of the link layer of the OSI model, in the present case in the form of Ethernet frames.

Each of these frames comprises an Ethernet header, a payload CU, and a trailer. The header in particular comprises the MAC address of the source of the frame, i.e. the Ethernet card of the transmitting terminal 3, the MAC address of the recipient of the frame, i.e. of the Ethernet card of the receiving terminal 9, and a “Type” field indicating the type of protocol used. The payload, with a size comprised between 46 and 1500 octets, corresponds to the data actually conveyed by the frame, and therefore comprises the data or part of the data transmitted by the transmitting terminal 3 to the receiving terminal 9. The trailer is an FCS (Frame Check Sequence) control field. This is an error detection code, allowing the recipient of the frame to detect certain errors having appeared during transmission of the frame.

The payload of an Ethernet frame having a maximum size limited to 1500 octets, the data transmitted by the transmitting terminal 3 to the receiving terminal 9 is generally transmitted in the form of a plurality of frames.

FIG. 3 illustrates the steps of the transmission method according to the disclosure carried out by the transmission device 5, during the transmission of each of these frames.

Such frames cannot be transmitted through the transit network N2, as they are not adapted to transmission on an IP network, not comprising any level 3 information of the OSI model. Furthermore, these frames are in no way protected, such that the transmission of these frames as they are through the transit network N2 would allow an attacker on that transit network N2 to access all of the transmitted data and attack the network N1 and/or the network N3.

Each frame TR transmitted by the transmitting terminal 3 is received by the analysis module 20 of the transmission device 5. In step 40, the analysis module 20 analyzes the frame TR to determine whether the size of that frame allows the transmission of the frame, after securing using the method according to the disclosure, on the transit network N2.

In fact, a maximum size authorized by the protocol of that network, called PMTU (Path Maximum Transmission Unit), is defined on all networks, such as an IP network or an Ethernet network. In the case of an IP network, this maximum size corresponds to the maximum number of octets of the assembly formed by the IP header and the IP data transmitted by that packet. In the case of a lower-level network, for example an Ethernet network, this maximum size corresponds to the maximum number of octets of the payload, by default 1500 if it is an Ethernet frame.

As will be described hereafter, the transmission of the frame TR from the network N1 to the transit network N2 comprises encapsulation of that frame in a secured encapsulation IP packet. Thus, the IP packet transmitted by the transmission device 5 through the transit network N2 has a larger size than the original frame TR, transmitted by the transmitting terminal 3, such that the size of this IP packet could be above the PMTU value of the transit network N2, preventing transmission of that IP packet on the network N2.

During step 40, the analysis module 20 compares the size T_{TR} of the frame TR to the maximum size Tₘₐₓ that frame could have without the IP packet obtained by encapsulation of that Ethernet frame exceeding the PMTU value of the network N2. This maximum size Tₘₐₓ is thus equal to the PMTU value of the network N2 minus the number of octets added to that frame during its encapsulation in an IP packet.

If the size T_{TR} of the frame TR is larger than that maximum size Tₘₐₓ, it is transmitted by the analysis module 20 to the fragmenting module 24. If the size T_{TR} of the frame TR is smaller than or equal to that maximum size Tₘₐₓ, it is transmitted by the analysis module 20 to the encapsulation and protection module 22.

During step 42, carried out only if the frame TR is sent to the fragmenting module 24, the frame TR is fragmented by the fragmenting module 24 into at least two portions, each of the portions having a size smaller than or equal to a predefined second maximum size T′ₘₐₓ<Tₘₐₓ, and the original frame TR being able to be reconstructed by concatenation of those portions.

Then, the fragmenting module 24 generates, from the N created portions, N frame fragments FTR, each of the fragments comprising a portion of the original frame TR and a fragmentation field. This fragmentation field comprises a frame identifier, making it possible to uniquely identify the frame TR from which the frame portion came, and a fragment identifier, indicating the position of that portion in the Ethernet frame, relative to the other portions of the frame resulting from that fragmentation. This fragmentation field has a size T_{f}. Defining a second maximum size T′ₘₐₓ<Tₘₐₓ thus makes it possible to ensure that the size of each fragment FTR remains smaller than the maximum size Tₘₐₓ, despite the addition of the fragmentation field to each frame portion.

Each of the frame fragments FTR is then transmitted by the fragmenting module 24 to the encapsulation and protection module 22.

During step 44, the encapsulation and protection module 22 generates, from the frame TR received from the analysis module 20 or each frame fragment FTR received from the fragmenting module 22, a secured encapsulation packet \hat{P}_{enc} of the network layer of the OSI model, for example according to an IPsec protocol in Tunnel mode (Internet Protocol Security), in particular according to the ESP (Encapsulating Security Payload) protocol.

To that end, during step 46, the encapsulation and protection module 22 generates a security encapsulation header E_{enc} and a first trailer CF_{enc}, and generates an encapsulation packet P_{enc}, by concatenating the header E_{enc}, of the frame TR or the frame fragment FTR to be encapsulated, and the trailer CF_{enc}.

The security encapsulation header E_{enc}, also called security header, is a level 3 security header of the OSI model, for example an ESP header.

The header E_{enc} for example comprises an IP header indicating a source address of the packet, i.e. the network address of the transmission device 5 on the network N2, for example its IP address, as well as a destination address of the packet, i.e. the network address of the transmission device 11 on the network N2, for example its IP address.

This header E_{enc} also comprises an identifier allowing a counterpart piece of equipment receiving the packet, in the present case the device 11, to identify the security policy applied to the secured packet and, if all or part of that packet is subsequently subject to encryption, to identify the key allowing the device 11 to decrypt it.

If the header E_{enc} is an ESP header, this identifier is for example an SPI (Security Parameters Index) field, indicating the security association (SA) used to protect the secured packet P_{enc}.

The header E_{enc} also comprises one or more security fields allowing the recipient, i.e. the device 11, to control the playback of the packets it receives, and thereby to prevent an attacker from intercepting certain packets to send them back later. For example, if the header E_{enc} is an ESP header, it comprises a SEQ or “Sequence” field, containing the sequence number of the security association used, such a number being incremented between each secured packet.

The trailer CF_{enc} in particular comprises data making it possible to make the packet transmitted on the transit network N2 anonymous, in particular to adjust the length of that packet to a predefined length, such that all of the packets transmitted by the device 5 on the transit network N2 have the same length.

This trailer CF_{enc} for example comprises an ESP trailer, comprising traffic padding data, the length of which is chosen so that the length of the secured packet is equal to a predefined length, a “Length” or “Pad Length” field, indicating the length of the traffic padding data, and a “Header” field, indicating the type of data borne by the encapsulation packet P enc, for example whether it involves a whole Ethernet frame or a frame fragment.

Then, during step 48 for cryptographic confidentiality protection, the encapsulation and protection module 22 applies cryptographic confidentiality protection to part of the encapsulation packet P_{enc} comprising the encapsulated frame TR or frame fragment FTR, and potentially the trailer CF_{enc}. This cryptographic protection is for example an encryption, making it possible to protect the confidentiality of the frame TR or frame fragment FTR before the transmission thereof on the transit network N2. The encrypted part of the packet can subsequently be decrypted using the key identified in the header E_{enc}.

During step 50 for cryptographic integrity protection, the encapsulation and protection module 22 applies cryptographic integrity protection to the entire encapsulation packet P_{enc} with the exception of the IP header, or the entire encapsulation packet P_{enc}. The purpose of this protection is to protect the integrity of the encapsulation packet P_{enc}, i.e. to prevent that packet from being modified by an attacker on the transit network N2. This integrity protection is for example a signature or the application of a hashing function.

The encapsulation and protection module 22 then adds a trailer CF₂ to the obtained packet, this trailer comprising an authentication code, resulting from the cryptographic integrity protection, making it possible to authenticate the packet and verify the integrity thereof, upon receipt of that packet by the device 11, after transmission of that packet on the transit network N2.

This trailer CF₂ is for example an ICV (Integrity Check Value) field.

Thus, at the end of step 50, the frame or frame fragment is encapsulated in a protected encapsulation packet, forming a secured packet P_{sec}.

The secured packet P_{sec} is then transmitted in step 54 by the device 5 on the transit network N2, intended for the transmission device 11.

FIG. 4 diagrammatically illustrates the structure of the secured packet P_{sec} transmitted on the transit network N2, in one particular embodiment of the disclosure. In this embodiment, the frame TR is an Ethernet frame, the secured packet P_{sec} is an IP packet, obtained by encapsulating the frame TR according to the IPsec protocol in ESP tunnel mode.

As previously described, the secured packet P_{sec} comprises the security encapsulation header E_{enc}, encrypted data CH comprising the frame TR and the first trailer CF_{enc}, and the second trailer CF₂, in that order.

The header E_{enc} comprises an IP header E_{IP} indicating the source and destination IP addresses, an SPI field, indicating the security association (SA) used, and an SEQ field for anti-replay.

The frame TR comprises a header indicating the MAC address of the network card of the source terminal 3, denoted MAC₃, the MAC address of the network card of the receiving terminal 9, denoted MAC₉, and the type of protocol used, a payload CU comprising the data to be transmitted, and an FCS control field.

The first trailer CF_{enc} comprises traffic padding data Bo, a “Length” field PL indicating the size of the traffic padding data, and a “Header” field NH, indicating that the encapsulation packet P_{sec} comprises a whole frame.

The frame TR and the first trailer CF_{enc} are thus present in encrypted form in the secured packet P_{sec}, the key making it possible to decrypt the data being identified in the SPI field of the header E_{enc}. Furthermore, the integrity of the SPI and SEQ fields of the header E_{enc}, the frame TR and the first trailer CF_{enc} is protected, the ICV trailer comprising data making it possible to verify the integrity of the data, upon receipt thereof by the device 11.

Thus, during the transmission of the secured packet P_{sec} on the transit network N2, neither the MAC addresses of the source and destination, nor the data carried by the frame TR are accessible in clear.

FIG. 5 illustrates the steps of the transmission method according to the disclosure carried out by the transmission device 11, upon receipt of the secured packet P_{sec} comprising a frame TR or frame fragment FTR, and transmitted by the transmission device 5, after transit of that packet on the network N2.

In a cryptographic verification step 60, the cryptographic verification module 26 of the device 11 analyzes the secured packet P_{sec} to verify the authenticity and integrity thereof, and decrypts the frame TR or frame fragment FTR and the first trailer CF_{enc}, if they have been encrypted.

To that end, in an analysis step 62, the cryptographic verification module 26 analyzes the header E_{enc} of the encapsulation packet P_{enc}, for example its SPI field if it is an ESP header, and identifies the security policy applied to the secured packet P_{sec}. If the frame TR or frame fragment FTR and the first trailer CF_{enc} are encrypted, the cryptographic verification module 26 identifies, from that header E_{enc}, the key making it possible to decrypt them. Furthermore, if this header E_{enc} comprises an anti-replay check field, for example a sequence number SEQ, the cryptographic verification module 26 identifies that number.

In step 64, the cryptographic verification module 26 verifies the authenticity and integrity of the secured packet P_{sec}. To that end, the cryptographic verification module 26 compares the authentication code, for example the ICV field, of the second trailer CF₂, to the code obtained from the received packet, this comparison making it possible to detect any changes that may have been made to that packet. The cryptographic verification module 26 also compares the anti-replay check field of the header E_{enc} to the check fields from the packets previously received by the device 11. This comparison makes it possible to determine whether the packet P_{sec} was transmitted by an enemy, who intercepted that packet during its initial transmission. Thus, if the anti-replay check field of the header E_{enc} is less than or equal to a check field of a packet previously received, the cryptographic verification module 26 rejects that packet in step 66.

Then, in a decryption step 68, carried out if the frame TR or frame fragment FTR and the first trailer CF_{enc} are encrypted, the cryptographic verification module 26 decrypts them using the key identified in the header E_{enc}.

At the end of the cryptographic verification step 60, the decrypted secured packet is then transmitted to the decapsulation module 28.

In a decapsulation step 70, the decapsulation module 28 extracts, from the secured decrypted packet, the frame TR or frame fragment FTR contained in that packet, by eliminating the security encapsulation header E_{enc} and the trailers CF_{enc} and CF₂.

In step 72, the decapsulation module 28 analyzes the data extracted from the secured packet, to determine whether it is a whole frame or a frame fragment.

If it is a whole frame TR, in step 74 the device 11 transmits that frame on the network N3, to the receiving terminal 9, and more specifically the network card of the receiving terminal 9 whereof the MAC address is indicated in the header of the frame TR.

If it is a frame fragment FTR, the decapsulation module 28 transmits that fragment to the reassembly module 30 in step 76.

As previously described, a frame fragment FTR comprises a fragmentation field and a portion of an original frame TR. In a reassembly step 78, the reassembly module 30 analyzes the fragmentation field of the frame fragment FTR, and identifies, from that field, the original frame TR from which that frame portion came, as well as the position of that portion in the original frame. The reassembly module 30 stores that portion as well as its position in the original frame until it has received all of the frame portions resulting from the fragmentation of the original frame. The reassembly module 30 then concatenates these frame portions to reconstitute the original frame.

Then, in step 80, the device 11 transmits the reconstituted frame TR on the network N3, intended for the receiving terminal 9, and more specifically the network card of the receiving terminal 9 whereof the MAC address is indicated in the header of the frame TR.

It will be understood from the preceding description how the transmission method and device according to the disclosure enable the secure transmission of data comprised in a frame of a data link layer, between two switched secured networks, through a non-secured routed network or a network with a different security level from the secured networks.

In particular, encapsulating a frame of a data link layer to be transmitted through the transit network in a secured packet of a network layer, for example encapsulating an Ethernet frame in an IPsec packet, makes it possible to obtain a packet that can be transmitted on all types of networks, unlike the original frame.

The security of the data is in particular ensured by the cryptographic integrity protection applied to the encapsulation packet P_{enc} and by the cryptographic confidentiality protection preferably applied to the encapsulated frame or frame fragment and the first trailer CF_{enc}.

In fact, the cryptographic integrity protection applied to the encapsulation packet P_{enc} makes it possible to check, upon receipt of the secured packet, that that packet has not been subject to modification during its transit on the network N2, and to prevent the replay of that packet. The integrity protection applied in particular to the encapsulation header E_{enc} makes it possible to protect against attacks on the encapsulation format, which can prevent the networks N1 and N3 from exchanging data.

Furthermore, the application of cryptographic confidentiality protection to the encapsulated frame or frame fragment and the first trailer CF_{enc} makes it possible to guarantee the confidentiality of the exchanged data and the identities of the transmitting 3 and receiving 9 terminals. In particular, when the secured packet P_{sec} comprises a frame fragment, the encryption of the fragmentation field makes it possible to prevent an attacker from disrupting the operation of the transmission device 11 by intercepting one or more secured packet(s) and modifying the field values thereof. Such a modification would for example result in causing storage of the fragments received by the transmission device 11 while waiting for a hypothetical last fragment.

Furthermore, since only the network addresses of the transmission devices 5 and 11 are indicated in the header of the secured packet, only those addresses can be seen on the transit network N2. It is therefore not possible, from that network N2, to know which protected terminals are exchanging the data.

The anonymity of the transmitted data is also reinforced owing to the addition of traffic padding data Bo in the encapsulation packet, the addition of such data guaranteeing that all of the packets transmitted on the transit network N2 are the same length. It is therefore not possible for an enemy on the network N2 to determine what type of data is being exchanged between the networks N1 and N3 simply by analyzing the length of the exchanged packets.

Furthermore, the implementation of such a method is less expensive than that of the method according to the prior art, since it makes it possible to exploit existing protocols such as an IPsec protocol.

It should, however, be understood that the examples of embodiments presented above are not limiting.

In particular, according to other embodiments, the transmission method is implemented in a point to multi-point mode between more than two secured networks, through several networks with lower security levels, each of the secured networks being equipped with at least one transmission device according to the disclosure.

1-10. (canceled)

11. A method for transmitting data over a communication channel between at least one starting network (N1) and at least one receiving network (N3) through a transit network (N2) with a different security level from the starting (N1) and receiving (N3) networks, comprising, during a transmission, from the starting network (N1) to the receiving network (N3) through the transit network (N2), data comprised in at least one frame (TR) of the data link layer, the frame (TR) comprising at least one header and a payload (CU):
a step for encapsulating the frame (TR) in at least one packet (P_{sec}) of a level network layer of the OSI model, compatible with the transit network (N2); and
a step for transmitting each packet (P_{sec}) to the receiving network (N3) through the transit network (N2), wherein each packet (P_{sec}) is a secured packet and in that the encapsulation step comprises the following steps:
generating at least one security encapsulation header (E_{enc});
forming at least one encapsulation packet (P_{enc}) comprising at least one of the security encapsulation header(s) (E_{enc}) and the frame (TR) or a fragment (FTR) of the frame;
forming each secured packet (P_{sec}) by applying at least one cryptographic protection to each encapsulation packet (P_{enc}).

12. The transmission method according to claim 11, wherein the encapsulation step also comprises a step for making each secured packet (P_{sec}) anonymous, comprising adjusting the length of each secured packet (P_{sec}) to a predefined length.

13. The transmission method according to claim 11, further comprising, during the transmission of at least one frame (TR) of a data link layer from the starting network (N1) to the receiving network (N3) through the transit network (N2), before the encapsulation step:
comparing a size (T_{TR}) of the frame (TR) to a predefined maximum size (Tₘₐₓ);
if the size (T_{TR}) of the frame (TR) is larger than the predefined maximum size (Tₘₐₓ); fragmenting the frame (TR) into at least two frame fragments (FTR), the size of each frame fragment (FTR) being smaller than or equal to the predefined maximum size (Tₘₐₓ).

14. The transmission method according to claim 11, further comprising the generation of at least one trailer (CF_{enc}), each encapsulation packet (P_{enc}) comprising at least one of the security encapsulation header(s) (E_{enc}), the frame (TR) or a fragment (FTR) of the frame and one of the trailer(s) (CF_{enc}).

15. The transmission method according to claim 14, wherein each trailer (CF_{enc}) comprises traffic padding data (Bo), the length of the traffic padding data (Bo) being chosen so that the length of each secured packet (P_{sec}) is equal to the predefined length; and
the encapsulation step comprises a step for making each secured packet (P_{sec}) anonymous, comprising adjusting the length of each secured packet (P_{sec}) to a predefined length.

16. The transmission method according to claim 11, further comprising, during a transmission of at least one secured packet (P_{sec}) from the transit network (N2) to the receiving network (N3), at least one step for receiving each secured packet (P_{sec}), and a step for transmitting the data to the receiving network (N3), each receiving step comprising:
cryptographic verification of the encapsulation packet (P_{enc}) comprised in the secured packet (P_{sec});
extraction of the frame (TR) or frame fragment (FTR) comprised in the encapsulation packet (P_{enc}).

17. The transmission method according to claim 13, comprising, if at least two encapsulation packets (P_{enc}) comprise a fragment (FTR) of the frame, an assembly of the fragments (FTR) of the frame comprised in the encapsulation packets (P_{enc}), before the step for transmitting the data to the receiving network (N3); and
further comprising, during the transmission of at least one frame (TR) of a data link layer from the starting network (N1) to the receiving network (N3) through the transit network (N2), before the encapsulation step:
comparing a size (T_{TR}) of the frame (TR) to a predefined maximum size (Tₘₐₓ);
if the size (T_{TR}) of the frame (TR) is larger than the predefined maximum size (Tₘₐₓ); fragmenting the frame (TR) into at least two frame fragments (FTR), the size of each frame fragment (FTR) being smaller than or equal to the predefined maximum size (Tₘₐₓ).

18. The transmission method according to claim 11, wherein the frame (TR) is an Ethernet frame.

19. The transmission method according to claim 11, wherein the secured packet comprises a secured packet (P_{sec}) according to an IPsec protocol.

20. A device for transmitting data on a communication channel between at least one starting network (N1) and a receiving network (N3) through a transit network (N2) with a different security level from the starting (N1) and receiving (N3) networks, comprising:
encapsulation means, capable of encapsulating a frame (TR) of a data link layer, comprising at least one header and a payload, in at least one packet (P_{sec}) of a network layer compatible with the transit network (N2); and
means for transmitting each packet (P_{sec}) toward the receiving network (N3) through the transit network,
wherein each packet (P_{sec}) is a secured packet and in that the encapsulation means comprise:
means for generating at least one security encapsulation header (E_{enc});
means for forming at least one encapsulation packet (P_{enc}) comprising at least one of the security encapsulation header(s) (E_{enc}) and the frame (TR) or a fragment (FTR) of the frame;
means for forming each secured packet (P_{sec}) by applying at least one cryptographic protection to each encapsulation packet (P_{enc}).

21. The transmission method according to claim 11, further comprising, during a transmission of at least one secured packet (P_{sec}) from the transit network (N2) to the receiving network (N3), at least one step for receiving each secured packet (P_{sec}), and a step for transmitting the data to the receiving network (N3), each receiving step comprising:
cryptographic verification of the encapsulation packet (P_{enc}) comprised in the secured packet (P_{sec});
extraction of the frame (TR) or frame fragment (FTR) comprised in the encapsulation packet (P_{enc}); and
further comprising, during the transmission of at least one frame (TR) of a data link layer from the starting network (N1) to the receiving network (N3) through the transit network (N2), before the encapsulation step:
comparing a size (T_{TR}) of the frame (TR) to a predefined maximum size (Tₘₐₓ);
if the size (T_{TR}) of the frame (TR) is larger than the predefined maximum size (Tₘₐₓ); fragmenting the frame (TR) into at least two frame fragments (FTR), the size of each frame fragment (FTR) being smaller than or equal to the predefined maximum size (Tₘₐₓ).

22. The transmission method according to claim 18, wherein the secured packet comprises a secured packet (P_{sec}) according to an IPsec protocol.
